(19) United States
(12) Patent Application Publication
(10) Pub. No.: US 2015/0080169 A1
(43) Pub. Date: Mar. 19, 2015

(54) POWERSHIFT TRANSMISSION

(71) Applicant: ZF Friedrichshafen AG, Friedrichshafen (DE)

(72) Inventors: Klaus SCHMID, Bermatingen (DE); Bernhard FESSLER, Kressbronn am Bodensee (DE); Herbert OTT, Meckenbeuren (DE); Bernd LUTZ, Uhldingen-Muhlhofen (DE)

(73) Assignee: ZF Friedrichshafen AG, Friedrichshafen (DE)

(21) Appl. No.: 14/289,682

(22) Filed: May 29, 2014

(30) Foreign Application Priority Data
Sep. 17, 2013 (DE) 10 2013 218 615.0

(51) Int. Cl. F16H 3/62

(52) U.S. Cl. CPC F16H 3/62; F16H 2200/201
USPC 475/317

(57) ABSTRACT

An automatic powershift transmission having a variable-speed transmission (2) with a transmission input shaft (4), a transmission output shaft (5). a plurality of gearsets (RS1, RS2, RS3) and a number of shifting elements (A, B, D, E, F). A starting element (3) is connected upstream of the transmission input shaft (4). The starting element (3) is in the form of a planetary gearset (6) having a ring gear (9), a planetary carrier (10) and a sun gear (12). The ring gear (9) and the planetary carrier (10) can be coupled to one another while the sun gear (12) can be locked with respect to the housing.

This application claims priority from German patent application serial no. 10 2013 218 615.0 filed Sep. 17, 2013.

### FIELD OF THE INVENTION

The invention concerns a powershift transmission.

### BACKGROUND OF THE INVENTION

Automatic variable-speed transmissions, particularly for commercial vehicles, as a rule comprise a starting element in the form of a torque converter which, in particular, brings about an increase of the torque delivered by the internal combustion engine. The disadvantages of such a torque converter are, on the one hand, the hydraulic losses caused by the slip between the pump and turbine wheel, and, on the other hand, the relatively large weight of the converter.

In DE 10 2008 041 887 A1 by the present applicant, in the case of hybrid drives for motor vehicles it has been proposed to replace the hydrodynamic torque converter with a transmission input stage having a high transmission ratio, wherein the transmission input stage is in the form of a planetary gearset with a sun gear, a planetary carrier and a ring gear. In this case the ring gear can be coupled to the internal combustion engine and/or the electric machine, the planetary carrier is connected to the transmission input shaft and the sun gear is fixed permanently relative to the transmission housing. This produces a fixed transmission ratio for the planetary transmission. By virtue of the transmission input stage, the torque of the electric machine is increased by around 70%.

### SUMMARY OF THE INVENTION

The purpose of the present invention is, in an automatic powershift transmission of the type mentioned to begin with, to reduce the losses occurring in the starting element.

This objective is achieved by the characteristics of the automatic powershift transmission described below. Advantageous design features emerge from the subordinate claims.

According to the invention, the torque converter previously usually present in an automatic powershift transmission is replaced by a planetary gearset wherein the ring gear and the planetary carrier of the planetary gearset can be coupled to one another and the sun gear can be fixed. During starting, this results in a transmission ratio between the drive input shaft and the transmission input shaft in the slow range, i.e. the torque delivered by the internal combustion engine is increased—similarly to the way it is by the hydrodynamic converter. This enables quick and easy starting. In particular, however, losses are low since there are no hydraulic losses and only geartooth frictional losses occur. Furthermore, the weight of an automatic transmission with a starting element according to the invention is lower compared with one having a conventional converter.

In a preferred embodiment at least one shifting element of the variable-speed transmission serves as the starting element, i.e. the shifting elements in any case present in the transmission additionally adopt a starting function, namely the bridging of the rotational speed difference between the driveshaft or transmission input shaft and the transmission output shaft when starting.

In another preferred embodiment, the planetary carrier can be coupled by means of a shifting clutch to the driveshaft, i.e. the two transmission elements, the ring gear and the planetary carrier, can be “locked” to one another so that they run synchronously. The clutch is engaged as soon as the starting process has ended; this eliminates the need for the starting transmission ratio.

In a further preferred embodiment, during the starting process the sun gear or the sun gear shaft is supported, i.e. held fixed relative to the housing, by means of a freewheel. Thus, during the starting process the planetary gearset operates with a fixed transmission ratio between the ring gear and the planetary carrier. As already mentioned, a transmission ratio is obtained in the slow range and the torque on the transmission input shaft is thereby increased.

According to another preferred embodiment, the ring gear is connected directly to the drive input shaft, i.e. the internal combustion engine drives the ring gear of the planetary gearset directly.

In a further preferred embodiment, the ring gear can be coupled to an electric machine, so that the electric machine preferably adopts the function of a starter-generator. Thus the internal combustion engine can be started by means of the electric machine (starter function), or the electric machine is driven by the internal combustion engine (generator function).

### BRIEF DESCRIPTION OF THE DRAWINGS

Example embodiments of the invention are illustrated in the drawing and are described in more detail below, so that further characteristics and/or advantages can emerge from the description and/or the drawings, which show:

FIG. 1: A schematic representation of an automatic powershift transmission with a starting element according to the invention, and

FIG. 2: A design of the starting element, with an integrated electric machine.

### DETAILED DESCRIPTION OF THE PREFERRED EMBODIMENTS

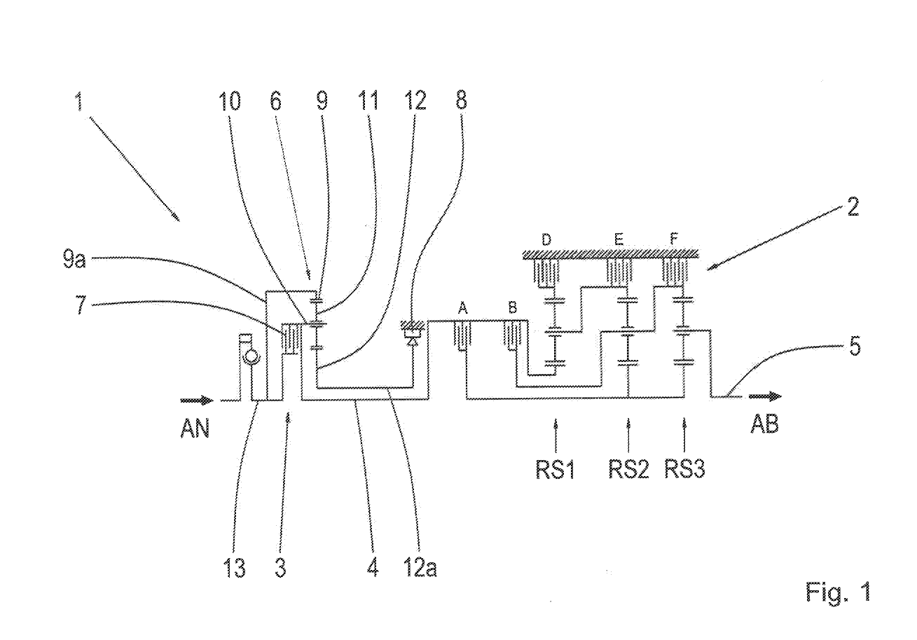

FIG. 1 shows an automatic powershift transmission 1, called automatic transmission for short in what follows, which comprises a drive input side AN, a drive output side AB, a variable-speed transmission 2 and a starting element 3. The variable-speed transmission 2 comprises a transmission input shaft 4 and a transmission output shaft 5, three planetary gearsets RS1, RS2, RS3 and five shifting elements A, B, D, E, F. With this variable-speed transmission 2, seven forward gears and one reversing gear can be engaged. Between the drive input side AN and the transmission input shaft 4 is arranged the starting element 3, which comprises a planetary gearset 6, a shifting clutch 7 and a freewheel 8. The planetary gearset 6 comprises a ring gear 9 with its ring gear carrier, a planetary carrier 10 with planetary gearwheels 11 and a sun gear 12 with its sun gear shaft 12a. The starting element 3 is driven by a driveshaft 13 of an internal combustion engine (not shown), which is connected, on the one hand, by way of the ring gear carrier 9a to the ring gear 9 and, on the other hand, to the input side (inner disk carrier) of the clutch 7. The planetary carrier 10, also referred to as the spider shaft 10, is connected on the one hand to the output side (outer disk carrier) of the clutch 7 and on the other hand to the transmission input shaft 4. The sun gear 12 is connected by way of its sun gear shaft 12a to a freewheel 8 supported on the housing. The ring gear 9, planetaries 11 and sun gear 12 mesh permanently with one another.

The automatic transmission 1 with the starting element 3 according to the invention works as follows:

When starting, the clutch 7 is opened and the sun gear 12 is held fast by the freewheel 8. This produces for the planetary transmission 6 a fixed transmission ratio from the ring gear 9 to the spider shaft 10, i.e. a step-down transmission ratio (as viewed from the drive input side AN to the drive output side AB). The torque from the internal combustion engine transmitted by the driveshaft 13 is thus increased. The starting process takes place by way of a starting clutch, whose function is performed by the shifting element A (clutch) and by the shifting element F (brake) of the variable-speed transmission 2. At the beginning of the starting process the clutch A is closed, so that the torque is transmitted via the sun gear to the gearset RS3. By closing the brake F in a controlled manner the ring gear of the gearset RS3 is braked, so that the drive output can take place via the spider shaft of the gearset RS3 to the transmission output shaft 5.

As soon as the starting process has ended, the clutch 7 is closed so that the spider shaft 10 and the ring gear 9 are connected with one another in a fixed manner, i.e. “locked”. The ring gear 9 and the spider shaft 10 then rotate synchronously. The freewheel 8 is unlocked, so that the sun gear 12 can rotate freely. The torque delivered by the internal combustion engine is now transmitted one-to-one to the transmission input shaft 4. The starting transmission ratio stage is omitted.

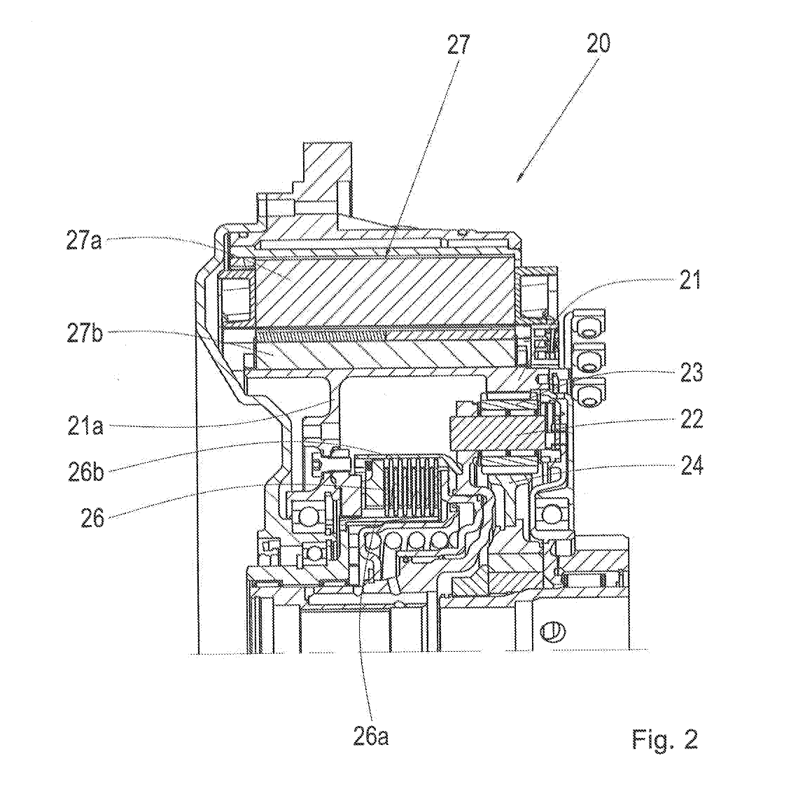

FIG. 2 shows a starting element 20 which constitutes a constructive design of the starting element 3 represented schematically in FIG. 1. The starting element 20 comprises a planetary gear system consisting of a ring gear 21, a planetary carrier 22 with planetary gearwheel 23 and a sun gear 24. The ring 21 gear is connected to a ring gear carrier 21 a which is mounted in a housing 25. Between the planetary carrier 22 and the ring gear carrier 21 a is arranged a shifting clutch in the form of a disk clutch 26, which has an inner disk carrier 26a connected to the ring gear carrier 21 a and an outer disk carrier 26b connected to the planetary carrier 22. Thus, the planetary carrier 22 or spider shaft 22 and the ring gear 21 can rotate separately from one another or be locked to one another. In a manner not explained in more detail, the sun gear 24 is connected to a freewheel (not indexed). The spider shaft 22 is connected to a transmission input shaft (not shown). To that extent the starting element 20 corresponds to the representation in FIG. 1.

In addition, in FIG. 2 an electric machine 27 is integrated in the starting element 20. The electric machine 27 has a stator 27a connected to the housing 25 and a rotor 27b connected to the ring gear carrier 21a. The electric machine 27 performs the function of a starter-generator and can therefore either start the internal combustion engine or be driven by the internal combustion engine as a generator. Recovery of braking energy (recuperation) is also possible.

### INDEXES

1 Automatic powershift transmission (automatic transmission)
2 Variable-speed transmission
3 Starting element
4 Transmission input shaft
5 Transmission output shaft
6 Planetary gearset
7 Clutch
8 Freewheel
9 Ring gear
9a Ring gear carrier
10 Planetary carrier
11 Planetary gearwheel
12 Sun gear
12a Sun gear shaft
13 Drive input shaft
20 Starting element
21 Ring gear
21a Ring gear carrier
22 Planetary carrier
23 Planetary gearwheel
24 Sun gear
25 Housing
26 Disk clutch
26a Inner disk carrier
26b Outer disk carrier
27 Electric machine
27a Stator
27b Rotor
AN Drive input side
AB Drive output side
RS1, RS2, RS3 Gearsets
A, B, D, E, F Shifting elements

1-6. (canceled)

7. An automatic powershift transmission comprising:
a variable-speed transmission (2) having a transmission input shaft (4), a transmission output shaft (5), a number of gearsets (RS1, RS2, RS3) and a number of shifting elements (A, B, D, E, F),
a starting element (3, 20) connected upstream of the transmission input shaft (4), and the starting element (3, 20) comprising a planetary gearset (6) with a ring gear (9, 21), a planetary carrier (10, 22) and a sun gear (12, 24), and
the ring gear (9, 21) and the planetary carrier (10, 22) being couplable and the sun gear (12, 24) being lockable.

8. The automatic powershift transmission according to claim 7, wherein the starting element (3) comprises a starting clutch in a form of at least one shifting element (A, F) of the variable-speed transmission (2).

9. The automatic powershift transmission according to claim 7, wherein a shifting clutch (7, 26) couples the planetary carrier (10, 22) to a ring gear carrier (9a, 21a).

10. The automatic powershift transmission according to claim 7, wherein a freewheel (8) locks the sun gear (12) relative to a housing.

11. The automatic powershift transmission according to claim 7, wherein a driveshaft (13), connected to an internal combustion engine, drives the starting element (3, 20) and the ring gear (9) is directly coupled to the driveshaft (13).

12. The automatic powershift transmission according to claim 7, wherein the ring gear (9) is couplable to a rotor (27b) of an electric machine (27).

13. An automatic powershift transmission comprising:
a variable-speed transmission (2) comprising a transmission input shaft (4), a transmission output shaft (5), a plurality of gearsets (RS1, RS2, RS3) and a plurality of shifting elements (A, B, D, E, F),
a starting element (3, 20) being connected to an upstream side of the transmission input shaft (4),
the starting element (3, 20) comprising a planetary gearset (6) comprising a ring gear (9, 21), a planetary carrier (10, 22) and a sun gear (12, 24), and
the ring gear (9, 21) and the planetary carrier (10, 22) being connectable with one another via a shifting clutch so as to be rotationally fixed with respect to each other, and the sun gear (12, 24) being lockable, via a freewheel, with respect to a housing.

14. The automatic powershift transmission according to claim 13, wherein the starting element comprises a starting clutch which is at least one shifting element of the variable-speed transmission.

15. The automatic powershift transmission according to claim 14, wherein an outer disk carrier of the shifting clutch is fixed to the planetary carrier and an inner disk carrier of the shifting clutch is fixed to the ring gear carrier, the outer and the inner disk carriers respectively supporting disks which engage with each one another, when the shifting clutch is actuated, so as to rigidly couple the planetary carrier to the ring gear carrier.

16. The automatic powershift transmission according to claim 15, wherein the planetary carrier rotationally supports at least one planet gear which constantly meshes with the sun gear and the ring gear.

17. The automatic powershift transmission according to claim 16, wherein the starting element is driven by a driveshaft which is connected to an internal combustion engine and the ring gear is constantly directly coupled to the driveshaft.

18. The automatic powershift transmission according to claim 17, wherein the ring gear is coupled to a rotor of an electric machine and a stator of the electric machine is fixed to the housing.

19. An automatic powershift transmission comprising:
a variable-speed transmission (2) having a transmission input shaft (4), a transmission output shaft (5), a plurality of gearsets (RS1, RS2, RS3) and a plurality of shifting elements (A, B, D, E, F),
a starting element (3, 20) connected upstream of the transmission input shaft (4), and the starting element (3, 20) comprising a planetary gearset (6) including a ring gear (9, 21), a planetary carrier (10, 22) and a sun gear (12, 24),
the ring gear (9, 21) and the planetary carrier (10, 22) being releasably couplable to one another via a clutch while the sun gear (12, 24) being lockable, via a freewheel, relative to a housing for preventing rotation of the sun gear,
a driveshaft (13), connected to an internal combustion engine, facilitates driving the starting element (3, 20), and
the ring gear (9) being directly coupled to the driveshaft (13).
